(19) United States
(12) Patent Application Publication
(10) Pub. No.: US 2023/0218952 A1
(43) Pub. Date: Jul. 13, 2023

(54) TABLE TENNIS BALL HAVING MARKING TO MAKE A BALL ROTATION DETECTABLE

(71) Applicant: ESN Deutsche Tischtennis Technologie GmbH, Hofheim (DE)

(72) Inventors: Matthias Ottenberg, Osnabrück (DE); Konrad Tiefenbacher, Saarbrücken (DE); Thomas Kraus, Coburg (DE)

(21) Appl. No.: 18/180,338

(22) Filed: Mar. 8, 2023

Related U.S. Application Data
(63) Continuation of application No. PCT/EP2022/057660, filed on Mar. 23, 2022.

(30) Foreign Application Priority Data
Mar. 23, 2021 (DE) 10 2021 202 843.8

(51) Int. Cl. A63B 39/00; A63B 45/02

(52) U.S. Cl. CPC A63B 39/00; A63B 45/02; A63B 2102/16

(57) ABSTRACT

A table tennis ball which has, on the spherical surface thereof, a marking to make a ball rotation measurable. The marking contains a number of marking points, which are distributed on the ball surface in such a way that the standard deviation of the lengths of the orthodromes between each of the marking points and the three nearest neighboring points thereof is at least 12% of the average value of these lengths, and the minimum length of the orthodromes between each of the marking points and the three nearest neighboring points thereof is at least 40% of the average value of these lengths.

### CROSS-REFERENCE TO RELATED APPLICATION

This application is a continuation, under 35 U.S.C. § 120, of copending International Patent Application PCT/EP2022/057660, filed Mar. 23, 2022, which designated the United States; this application also claims the priority, under 35 U.S.C. § 119, of German Patent Application DE 10 2021 202 843.8, filed Mar. 23, 2021; the prior applications are herewith incorporated by reference in their entirety.

### FIELD AND BACKGROUND OF THE INVENTION

The invention relates to a table tennis ball (also “ball” in short hereinafter) according to the preamble of the independent claim, having a spherical ball surface and a marking applied to the ball surface for making a ball rotation metrologically detectable, wherein the marking includes a number of marking points. Such a table tennis ball is known, for example, from international patent disclosure WO 2020 096 120 A1.

In table tennis, in addition to the ball speed, the ball rotation (also referred to as “spin”) is of decisive importance, since the ball rotation decisively influences the flight path of the ball and the rebound behavior of the ball on the table tennis table and the paddle of the opposing player. In particular in competitive table tennis sport, there is therefore a strong demand for the most precise possible determination of the spin in flight, for example, to enable training an objective control and targeted improvement of the striking technique of table tennis players. Moreover, there is a demand in the case of tournament players in the context of game moderation or sports reporting to measure and analyze the ball movement of table tennis balls—as much as possible in real time.

To make the spin of table tennis balls in flight visible, the application of markings to the ball surface is known in principle. Thus, for example, in the German Wikipedia entry on the theme “Tischtennisball [table tennis ball]” (https://de.wikipedia.org/wiki/Tischtennisball; version of 04.17.2020, 8:51 PM), a table tennis training ball is depicted, on the ball surface of which a colored pattern made up of extensive colored areas is printed as a marking for spin recognition.

In the table tennis ball known from international patent disclosure WO 2020 096 120 A1, the marking applied for spin recognition comprises, on the other hand, six marking points, which are distributed uniformly over the ball surface. Each marking point has a diameter between 5 mm (millimeter) and 13 mm.

Similarly as in table tennis, there is also a demand for measuring the ball rotation in flight in golf. Markings applied to the ball surface, in particular in the form of point patterns, are also used here to make the ball rotation metrologically detectable upon teeing. Corresponding golf balls are known, for example, from Chinese patent CN 107 543 530 A (corresponding to U.S. Pat. No. 10,217,228), South Korean patent KR 102 101 512 B1, U.S. patent publication No. 2018 0353828 A1, and U.S. Pat. No. 7,062,082 B2. The markings disclosed here each have one or more groups having multiple closely neighboring marking points.

Alternatively, markings which have one-dimensional or two-dimensional structures, for example, strokes, are used according to Chinese patent CN 106 643 662 A for spin recognition in golf balls. It is in turn alternatively proposed in Japanese patent application JP 2016 218014 A that a producer identification applied to a golf ball be used as a marking for making the spin detectable.

While automatic methods for spin measurement of golf balls have already been successfully used, however, corresponding measuring methods have not yet become established in table tennis. This is above all because conventional measuring methods are too slow to be reasonably usable in table tennis. This is because in comparison to golf, table tennis is a very fast sport which is characterized by a high frequency of hits; during a rally the ball typically traverses the net more than one time per second. In addition, this is made more difficult in that—in contrast to golf—the position and orientation of the ball is not known at the beginning of the measurement. While in golf the spin measurement typically takes place upon teeing, before which the ball rests (so that the position and orientation of the ball are precisely defined), the spin of a table tennis ball is measured in flight (usually when traversing the net). However, since the flight path of a table tennis ball is only predictable with great inaccuracy a priori, a measuring device for spin calculation of table tennis balls first has to search for the ball before it can measure the spin, which costs a significant amount of measuring time. Moreover, the orientation of the table tennis ball at the point in time of its detection is also not known a priori by the measuring apparatus and first has to be ascertained. For these reasons, a spin measurement of table tennis balls in flight has heretofore only been possible under favorable circumstances and, measured in the course of play, only with a long-time delay. A reliable spin ascertainment in every play situation (in particular approximately in real time, thus approximately during the time between two hits) is presently not yet available.

### SUMMARY OF THE INVENTION

The invention is based on the object of enabling particularly fast and error-proof automatic ascertainment of the ball rotation (spin) in flight of a table tennis ball.

This object is achieved according to the invention by the features of the independent claim. Accordingly, a table tennis ball having a spherical ball surface and a marking applied on the ball surface for making a ball rotation (spin) metrologically detectable is specified. As is known per se from international patent disclosure WO 2020 096 120 A1, the marking comprises a number of marking points. The number of the marking points is described hereinafter with the variable N. The radius of the table tennis ball is described hereinafter with the variable R.

The marking relevant for making the spin detectable preferably consists exclusively of the marking points. In this case, the marking is in other words solely a point pattern which has no further structures except for the mentioned marking points. The table tennis ball can also have further structures or patterns on its ball surface in this variant of the invention. However, such further structures then do not belong to the marking relevant for the spin ascertainment and are also not evaluated in the spin ascertainment.

According to the invention, the distribution of the marking points on the ball surface is characterized by a number of criteria.

According to a first criterion, the standard deviation of the lengths of the orthodromes between each of the marking points and its three closest neighboring points is at least 12% of the mean value of these lengths. In the calculation of the standard deviation, the point distances of all marking points to their respective three closest neighboring points are thus taken into consideration.

According to a second criterion, the minimum length of the orthodromes between each of the marking points and its three closest neighboring points is at least 40% of the mean value of the length of these orthodromes. In other words, according to the second criterion none of the orthodromes has a length between one of the marking points and one of its three closest neighboring points which falls below 40% of the mean value of the lengths of these orthodromes.

Additionally or alternatively to the second criterion, the point distribution is characterized in that the minimum length of the orthodromes between each of the marking points and its three closest neighboring points is at least 120% of the quotient of the ball radius to the square root of the point number. In other words, according to the third criterion, none of the orthodromes has a length between one of the marking points and one of its three closest neighboring points that falls below 120% of the quotient of the ball radius to the square root of the point number.

In the second and third criterion as well, the point distances of all marking points to their respective three closest neighboring points are each taken into consideration.

The invention is based on the finding that the implementability of an error-proof and sufficiently numerically simple and thus rapid ascertainment of the spin of the table tennis ball is substantially dependent on the type of the marking applied to the table tennis ball.

In a first step, the invention proceeds here from the consideration that markings which have one-dimensional or two-dimensional structures are unfavorable for the automatic spin ascertainment, since such structures can only be detected by numerically complex and thus comparatively time-intensive image recognition methods (in particular by segmenting). In contrast thereto, punctiform structures are known to be detectable with very little numeric expenditure. The invention therefore concentrates on the development of a marking which consists of a number of marking points or at least comprises such marking points.

The uniform distribution of marking points proposed in international patent disclosure WO 2020 096 120 A1, however, is recognized as disadvantageous since it does not permit unambiguous recognition of the ball orientation from a photographic depiction of the table tennis ball. Rather, in the ball proposed here, there are six different orientations which depict the marking in itself and which are therefore not distinguishable in a photographic recording of the ball. It is known that this redundancy of the marking can have the result that in a comparative evaluation of a time sequence of images of the ball, the marking points recognizable in the various images can be assigned incorrectly to one another, which can in turn result in errors in the spin calculation.

However, a grouping of marking points, as is proposed in CN 107 543 530 A, KR 102 101 512 B1, US 2018 0353828 A1, and U.S. Pat. No. 7,062,082 B2, has proven not to be expedient for the spin ascertainment in table tennis. This is above all because the orientation of the ball is not known at the beginning of the metrological detection in table tennis—unlike during teeing in golf. Since table tennis balls can therefore enter the detection range of a measuring device in arbitrary orientations, at the point in time of the detection, many of the measurement points concentrated in groups will not be located on the ball side facing toward the measuring device with comparatively high probability and will therefore be imaged only poorly or not at all. Under these circumstances, a conventional spin ascertainment based on an evaluation of a time sequence of images of the ball would regularly fail. It is known that this problem can be solved by a denser arrangement of point groups on the ball surface. However, this would in turn—due to the then higher number of marking points and the denser packing thereof—be at the cost of increased numeric expenditure for the identification of the marking points and lower precision in the spin ascertainment.

In consideration of the disadvantages of the prior art, the invention proposes a middle course. It is based on the concept of distributing the marking points globally (i.e., with respect to the entirety of the marking points) as homogeneously as possible, but locally (i.e., with respect to the individual marking points and their closest neighboring points) as inhomogeneously and irregularly (pseudo-randomly) as possible.

Due to the global homogeneity of the point distribution, in each possible orientation of the ball, a particularly large subgroup of marking points can be seen well, even and in particular if the marking as a whole is only formed from a comparatively small number of marking points. This ensures a numerically uncomplicated identification of the detected marking points. However, the identification of the individual marking points is significantly simplified here by the local inhomogeneity of the point distribution, since the individual marking points can be recognized in an easy, unambiguous, and error-proof manner on the basis of their arrangement in relation to the neighboring points.

The above-described properties, thus the global homogeneity, on the one hand, and the local inhomogeneity of the point distribution, on the other hand, of the marking according to the invention may be described particularly simply and unambiguously on the basis of the lengths of the orthodromes between each marking point and its three closest neighboring points. The term “orthodrome” refers here to the shortest connection between the respectively observed marking points on the spherical ball surface.

The “closest neighboring point” of an observed marking point (“central point”) always refers to that marking point which is connected to the central point via the orthodrome having the shortest length. The “second-closest neighboring point” and “third-closest neighboring point” of the central point accordingly always refer to those marking points which are connected to the central point via the orthodrome having the second-shortest length or the third-shortest length, respectively. In the meaning of this definition, each of the marking points has a closest neighboring point, a second-closest neighboring point, and a third-closest neighboring point and can represent the central point according to this definition. The marking is preferably selected here so that for each central point, the closest three neighboring points are at different distances in pairs, so that these neighboring points can be assigned to the respective central point unambiguously as the closest, second-closest, and third-closest neighboring point. In the scope of the invention, however, one or more marking points can also be at equal distances from two of their three closest neighboring points. In individual cases, in other words, the closest neighboring point and the second-closest neighboring point and/or the second-closest neighboring point and the third-closest neighboring point can be at equal distances from the central point.

The group of marking points which is formed from the respective observed marking point (central point) and its three closest neighboring points is also referred to hereinafter as a “four-point network”. The marking has a number of such four-point networks corresponding to the number of the marking points.

For language simplification, the length of an orthodrome is designated in each case as a “point distance” above and hereinafter. The respective point distance is measured here—in accordance with the course of the associated orthodrome—along the ball surface.

The lengths of orthodromes which connect the respective central point of an observed four-point network to one of its three closest neighboring points are referred to hereinafter as “central point distances” and are described by the formula symbol Z_{i,j}. The control variable i (with i=1, . . . N) designates in this case that marking point which is viewed as the central point in the respective context. The control variable j (with j=1, 2, 3) designates the closest, second-closest, and third-closest neighboring point to the ith central point. The formula symbol Z_{5,2} in this meaning designates, for example, the central point distance between the fifth marking point viewed as the central point and its second-closest neighboring point.

The observation of the four-point networks introduced above has proven to be particularly advantageous, since the three closest neighboring points are known, with approximately uniform distribution of the marking points, to particularly frequently form a more or less pronounced and closed first shell around the respective central point. The three closest neighboring points are distinguished here in that they have point distances to the central point similar to one another which—depending on the point number and homogeneity of the pattern—is more or less significantly different from the point distances of the more remote neighboring points.

The above-described first criterion of the point distribution, according to which the standard deviation (hereinafter σ) of the lengths of the orthodromes between each of the marking points and its three closest neighboring points is at least 12% of the mean value (hereinafter μ) of these lengths, may thus be written as:

$$\frac{σ}{μ} \geq 12 \% \qquad equation 1$$

with

$$σ = \sqrt{\frac{{\sum }_{i = 1 : j = 1}^{N : 3} {( {Z}_{i , j} - μ )}^{2}}{3 \cdot N}} \qquad equation 2$$

$$and μ = \frac{{\sum }_{i = 1 : j = 1}^{N : 3} {Z}_{i , j}}{3 \cdot N} . \qquad equation 3$$

The above-mentioned standard deviation a of the central point distances Z_{i,j} is preferably at least 15% of the associated mean value μ. As is apparent from equations 2 and 3, in the calculation of the standard deviation a and the mean value μ, in each case summing is carried out over the three closest (central) point distances Z_{i,j} of all marking points Pᵢ, thus over Z_{1,1}, Z_{1,2}, Z_{1,3}, Z_{2,1}, Z_{2,2}, Z_{2,3}, . . . , Z_{N,1}, Z_{N,2}, Z_{N,3}.

A lower value of the standard deviation a indicates that in any case for most marking points Pᵢ, the three closest neighboring points are located in a comparatively thin circular ring around the marking point Pᵢ viewed as the central point in each case or that—in other words—in any case most marking points Pᵢ are arranged at very similar point distances to their three closest neighboring points. The parameters σ and σ/μ therefore each represent a measure of the homogeneity of the point distribution. It is ensured by the above-mentioned minimum value of the standard deviation that the point distribution within the four-point networks is not excessively homogeneous.

The second criterion of the above-described point distribution, according to which the minimum length of the orthodromes between each of the marking points and its three closest neighboring points, thus the smallest (central) point distance dₘᵢₙ on the ball surface, is at least 30% of the mean value of these lengths, may be written as:

dₘᵢₙ=min{Z_{i,j}|i=1, . . . ,N;j=1,2,3}≥40%·μ Equation 4.

This smallest (i.e., minimum) point distance dₘᵢₙ is preferably even at least 50%, in particular at least 60% of the associated mean value μ. As can be seen from equation 4, the second criterion also applies for respective three closest (central) point distances Z_{i,j} of all marking points Pᵢ, thus for Z_{1,1}, Z_{1,2}, Z_{1,3}, Z_{2,1}, Z_{2,2}, Z_{2,3}, . . . , Z_{N,1}, Z_{N,2}, Z_{N,3}.

An excessively small distance of the marking points from one another is precluded by this second criterion of the point distribution. Therefore, in particular a cluster formation of marking points is precluded. The second criterion therefore guarantees an approximately global homogeneity of the point distribution.

A further measure of the global homogeneity of the point distribution is the minimum (central) point distance dₘᵢₙ in relation to the ball radius R. With the best possible uniform distribution of N marking points on the ball surface, the marking points Pᵢ are on average as far away from one another as possible. Point pairs with outstandingly low point distance (i.e., point groups of closely adjacent marking points) are avoided, in other words. It can approximately be assumed that in the case of the best possible uniform distribution, each of the marking points is arranged in a different Nth of the ball surface, that thus each of the marking points is arranged more or less centrally in an assigned partial area of the ball surface, in which no other marking point is located, wherein each of these partial areas respectively has an extension A_{P} of one Nth of the ball surface.

$${A}_{P} = \frac{4 \cdot π \cdot {R}^{2}}{N} . \qquad Equation 5$$

If one again assumes these partial areas approximately as planar circular areas, the diameter d_{G} of the partial areas may thus be estimated from equation 5 and the formula for the surface area of a circle (A_{P}≈0.25·π·d_{G}²):

$${d}_{G} \approx \frac{4 \cdot R}{\sqrt{N}} . \qquad Equation 6$$

The diameter d_{G} is thus a measure of the typical distance of uniformly distributed marking points to their respective neighboring points on the ball surface. As is apparent from equation 6, this typical distance decreases approximately with the square root of the point number N. Since the extension of the ball surface is limited, the distance between marking points generally cannot be increased without the point distance decreasing at another point of the ball surface. The ratio of the minimum point distance dₘᵢₙ to the diameter d_{G} is thus a measure of how strongly the point distribution deviates from global homogeneity.

According to the above-mentioned third criterion, the minimum point distance dₘᵢₙ is at least 30% of the typical distance d_{G} calculated according to equation 6 or—expressed equivalently—at least 120% (thus 1.2 times) the quotient of the ball radius R to the square root of the point number N:

$${d}_{min} = min \{ {Z}_{i , j} \vert i = 1 , … , N ; j = 1 , 2 , 3 \} \geq 30 \% \cdot \frac{4 \cdot R}{\sqrt{N}} = 120 \% \cdot \frac{R}{\sqrt{N}} . \qquad Equation 7$$

The minimum point distance dₘᵢₙ is preferably at least 37.5%, in particular at least 45% of the typical distance d_{G}. Expressed equivalently, the minimum point distance dₘᵢₙ is preferably at least 150% (thus 1.5 times), in particular at least 180% (thus 1.8 times) the quotient of the ball radius R to the square root of the point number N. In a pattern having eighteen marking points (N=18), the minimum point distance dₘᵢₙ is thus at least 28%, preferably at least 35%, and in particular at least 42% of the ball radius R.

As mentioned above, the second criterion and the third criterion are taken into consideration in the scope of the invention alternatively to one another or in combination with one another, but always in combination with the first criterion, for characterizing the ball pattern according to the invention.

Lengths of orthodromes which connect the three closest neighboring points to one another are referred to as “peripheral point distances” Q_{i,k} in distinction from the central point distances Z_{i,j}. The control variable i again designates the marking point viewed as the central point here. In contrast, the control variable k (with k=1, 2, 3) identifies:

for k=1, the point distance between the closest neighboring point and the second-closest neighboring point,

for k=2, the point distance between the second-closest neighboring point and the third-closest neighboring point,

for k=3, the point distance between the third-closest neighboring point and the closest neighboring point

of the ith marking point. The formula symbol Q_{5,2} picked out by way of example therefore designates in this meaning the peripheral point distance between the second-closest neighboring point and the third-closest neighboring point of the fifth marking point viewed as the central point.

In one preferred embodiment of the invention, the marking points are distributed according to a fourth criterion on the ball surface in such a way that the range (hereinafter ΔQᵢ) of the peripheral point distances Q_{i,k} of each four-point network, or in other words the difference between the longest orthodrome and the shortest orthodrome between the three closest neighboring points of each marking point, is greater than 30% of the above-defined mean value p of the central point distances Z_{i,j}:

$$\frac{Δ {Q}_{i}}{μ} = \frac{max \{ {Q}_{i , j} \vert i = 1 , 2 , 3 \} - min \{ {Q}_{i , j} \vert i = 1 , 2 , 3 \}}{μ} > 30 \% \qquad equation 8$$

$$for each i = 1 , 2 , … , N .$$

This fourth property of the point distribution according to equation 8 can advantageously be used both in combination with one of the above-described features of the marking and also separate therefrom in a table tennis ball according to the preamble of the independent claim for characterizing a particularly suitable point distribution and is insofar also considered to be an independent invention. The range ΔQᵢ is preferably greater than 35% and in particular even greater than 40% of the mean value μ.

The preferred definition of a lower limit for the range ΔQᵢ is based on the finding that this range ΔQᵢ describes how strongly the triangle formed by the three closest neighboring points of a four-point network deviates from an equilateral triangle and thus a locally homogeneous point distribution. A sufficiently large value of the range ΔQᵢ is thus known to represent a particularly informative amount for the desired local inhomogeneity of the point distribution.

In preferred embodiments of the invention, the number of the marking points is between 13 and 25, preferably between 16 and 21, and in particular 18 or 19. This is based on the experience that a number of 18 or 19 marking points distributed on the ball surface permits optimized spin recognition with respect to the numeric expenditure and the reliability.

In the case of markings which have fewer marking points, situations occur—more frequently with decreasing number of the marking points—in which sufficient marking points cannot be recognized well in an image of the ball to be able to unambiguously identify the recognizable marking points. This can result in inaccuracies or errors in the spin calculation.

With increasing number of the marking points, on the other hand, the number of possibilities to which a metrologically detected group of marking points has to be compared in order to identify them increases disproportionately. In this way, markings which have more than 19 marking points in turn cause increased numeric expenditure in the spin ascertainment.

To a less pronounced extent, the advantages intended by the invention are also achieved by markings having 16, 17, 20, or 21 marking points, however; to an even less pronounced extent, by markings which comprise 13 to 15 or 22 to 25 marking points.

The diameter of each marking point is preferably selected such that it is between 10% and 24%, preferably between 15% and 20%, and in particular 17.5% of the ball radius. In absolute specifications, the diameter of each marking point is preferably between 2.0 mm and 4.8 mm, preferably between 3.0 and 4.0 mm, and in particular 3.5 mm. This dimensioning of the marking points has proven to be particularly advantageous since the marking points are, on the one hand, sufficiently large to make them reliably detectable on images of the ball even under unfavorable circumstances (for example, at comparatively large distance of the ball to the measuring device). On the other hand, however, the marking points thus dimensioned are sufficiently small that they can be treated in usable approximation as punctiform (i.e., dimensionless) structures, by which a numerically simple image evaluation is enabled. A simple image evaluation is also promoted in a further optional embodiment in that all marking points have the same shape and size.

In one advantageous embodiment, the marking points are distinguished by an infrared absorption characteristic or infrared reemission characteristic different from the remaining ball surface, so that the marking points stand out in a contrasting manner from the remaining ball surface in the infrared range (IR) of the electromagnetic radiation spectrum, in particular in an infrared image of the table tennis ball. In particular, the marking points are applied by means of an infrared-sensitive paint to the ball surface (wherein this infrared-sensitive paint is used only for the marking points, but not for other possibly present identifiers or patterns on the ball surface). This feature enables automatic spin determination by recording the ball by means of an infrared camera, which is particularly insensitive to interference in the spectral range of visible light (for example, blinding by headlights or flashes). Moreover, a selective recording of the marking for the purpose of the spin ascertainment is enabled by the contrasting infrared absorption characteristic or infrared reemission characteristic. The ball can in this way be provided substantially freely with further patterns or imprints in addition to the marking, without this interfering with the spin ascertainment.

In a further embodiment of the invention, the marking is formed such that the marking points again stand out in a contrasting manner from the background of the remaining ball surface due to the use of a specific common color in the visible range of the electromagnetic radiation spectrum. This feature again enables a selective recording of the marking for the purpose of the spin ascertainment, for example, by recording a color-filtered light image of the table tennis ball or by subsequent image processing. This feature thus also enables the ball to be provided with further patterns or imprints (in one or more other colors), without this interfering with the spin ascertainment.

In one particularly advantageous embodiment, the table tennis ball has a marking having eighteen marking points. These marking points are designated generally hereinafter as Pᵢ (with i=1, 2, . . . , 18). These eighteen marking points are arranged, each measured at the ball radius R, in the central point distances Z_{i,j} specified hereinafter to their closest neighboring points:

TABLE 1
central point distances for a preferred
marking having eighteen marking points

| | | central point distance | | |
|---|---|---|---|---|
| central | neighboring | | preferred | |
| point | point | Designation | value | tolerance |
| P₁ | P₂ | Z_{1, 1}/R | 0.54 | In each case ±20%, |
| P₁ | P₅ | Z_{1, 2}/R | 0.91 | preferably ±10%, |
| P₁ | P₁₇ | Z_{1, 3}/R | 0.99 | in particular ±5% |
| P₂ | P₁ | Z_{2, 1}/R | 0.54 | of the preferred |
| P₂ | P₄ | Z_{2, 2}/R | 0.72 | value, for example, |
| P₂ | P₅ | Z_{2, 3}/R | 0.83 | 0.54 ± 0.11, |
| P₃ | P₁₀ | Z_{3, 1}/R | 0.78 | preferably |
| P₃ | P₁₅ | Z_{3, 2}/R | 0.84 | 0.54 ± 0.05, |
| P₃ | P₈ | Z_{3, 3}/R | 0.87 | in particular |
| P₄ | P₂ | Z_{4, 1}/R | 0.72 | 0.54 ± 0.03 |
| P₄ | P₁₂ | Z_{4, 2}/R | 0.84 | |
| P₄ | P₅ | Z_{4, 3}/R | 0.85 | |
| P₅ | P₁₂ | Z_{5, 1}/R | 0.79 | |
| P₅ | P₂ | Z_{5, 2}/R | 0.83 | |
| P₅ | P₄ | Z_{5, 3}/R | 0.85 | |
| P₆ | P₁₂ | Z_{6, 1}/R | 0.67 | |
| P₆ | P₁₈ | Z_{6, 2}/R | 0.73 | |
| P₆ | P₁₅ | Z_{6, 3}/R | 0.94 | |
| P₇ | P₁₆ | Z_{7, 1}/R | 0.59 | |
| P₇ | P₁₇ | Z_{7, 2}/R | 0.76 | |
| P₇ | P₁₅ | Z_{7, 3}/R | 0.90 | |
| P₈ | P₁₅ | Z_{8, 1}/R | 0.82 | |
| P₈ | P₃ | Z_{8, 2}/R | 0.87 | |
| P₈ | P₁₁ | Z_{8, 3}/R | 0.89 | |
| P₉ | P₁₄ | Z_{9, 1}/R | 0.51 | |
| P₉ | P₁₈ | Z_{9, 2}/R | 0.91 | |
| P₉ | P₈ | Z_{9, 3}/R | 0.95 | |
| P₁₀ | P₁₃ | Z_{10, 1}/R | 0.75 | |
| P₁₀ | P₁₇ | Z_{10, 2}/R | 0.75 | |
| P₁₀ | P₃ | Z_{10, 3}/R | 0.78 | |
| P₁₁ | P₁₃ | Z_{11, 1}/R | 0.82 | |
| P₁₁ | P₁₀ | Z_{11, 2}/R | 0.88 | |
| P₁₁ | P₆ | Z_{11, 3}/R | 0.89 | |
| P₁₂ | P₅ | Z_{12, 1}/R | 0.67 | |
| P₁₂ | P₅ | Z_{12, 2}/R | 0.79 | |
| P₁₂ | P₄ | Z_{12, 3}/R | 0.84 | |
| P₁₃ | P₁₀ | Z_{13, 1}/R | 0.75 | |
| P₁₃ | P₁₁ | Z_{13, 2}/R | 0.82 | |
| P₁₃ | P₁ | Z_{13, 3}/R | 1.02 | |
| P₁₄ | P₉ | Z_{14, 1}/R | 0.51 | |
| P₁₄ | P₄ | Z_{14, 2}/R | 0.92 | |
| P₁₄ | P₁₁ | Z_{14, 3}/R | 0.98 | |
| P₁₅ | P₈ | Z_{15, 1}/R | 0.82 | |
| P₁₅ | P₃ | Z_{15, 2}/R | 0.84 | |
| P₁₅ | P₇ | Z_{15, 3}/R | 0.90 | |
| P₁₆ | P₇ | Z_{16, 1}/R | 0.59 | |
| P₁₆ | P₁₇ | Z_{16, 2}/R | 0.74 | |
| P₁₆ | P₅ | Z_{16, 3}/R | 1.0 | |
| P₁₇ | P₁₆ | Z_{17, 1}/R | 0.74 | |
| P₁₇ | P₁₀ | Z_{17, 2}/R | 0.75 | |
| P₁₇ | P₇ | Z_{17, 3}/R | 0.76 | |
| P₁₈ | P₆ | Z_{18, 1}/R | 0.73 | |
| P₁₈ | P₁₂ | Z_{18, 2}/R | 0.88 | |
| P₁₈ | P₉ | Z_{18, 3}/R | 0.91 | |

The arrangement of the marking points Pᵢ according to Table 1 can advantageously be used both in combination with one of the above-described features of the marking and also separately therefrom in a table tennis ball according to the preamble of claim 1 and is insofar also considered to be an independent invention.

Furthermore, the neighboring points of each four-point grid are preferably arranged in relation to one another at the following peripheral point distances Q_{i,k}:

TABLE 2
Peripheral point distances for a preferred
marking having eighteen marking points.

| neighbor- | neighbor- | peripheral point distance | | |
|---|---|---|---|---|
| ing | ing | | preferred | |
| point | point | designation | value | tolerance |
| P₂ | P₅ | Q_{1, 1}/R | 0.83 | In each case ±20%, |
| P₅ | P₁₇ | Q_{1, 2}/R | 1.57 | preferably ±10%, |
| P₁₇ | P₂ | Q_{1, 3}/R | 1.53 | in particular ±5% |
| P₁ | P₄ | Q_{2, 1}/R | 1.24 | of the preferred |
| P₄ | P₅ | Q_{2, 2}/R | 0.85 | value, for example, |
| P₅ | P₁ | Q_{2, 3}/R | 0.91 | 0.83 ± 0.17, |
| P₁₀ | P₁₅ | Q_{3, 1}/R | 1.61 | preferably |
| P₁₅ | P₈ | Q_{3, 2}/R | 0.82 | 0.83 ± 0.08, |
| P₈ | P₁₀ | Q_{3, 3}/R | 1.45 | in particular |
| P₂ | P₁₂ | Q_{4, 1}/R | 1.39 | 0.83 ± 0.04 |
| P₁₂ | P₅ | Q_{4, 2}/R | 0.79 | |
| P₅ | P₂ | Q_{4, 3}/R | 0.83 | |
| P₁₂ | P₂ | Q_{5, 1}/R | 1.39 | |
| P₂ | P₄ | Q_{5, 2}/R | 0.72 | |
| P₄ | P₁₂ | Q_{5, 3}/R | 0.84 | |
| P₁₂ | P₁₈ | Q_{6, 1}/R | 0.88 | |
| P₁₈ | P₁₅ | Q_{6, 2}/R | 0.97 | |
| P₁₅ | P₁₂ | Q_{6, 3}/R | 1.57 | |
| P₁₆ | P₁₇ | Q_{7, 1}/R | 0.74 | |
| P₁₇ | P₁₅ | Q_{7, 2}/R | 1.60 | |
| P₁₅ | P₁₆ | Q_{7, 3}/R | 1.38 | |
| P₁₅ | P₃ | Q_{8, 1}/R | 0.84 | |
| P₃ | P₁₁ | Q_{8, 2}/R | 1.00 | |
| P₁₁ | P₁₅ | Q_{8, 3}/R | 1.59 | |
| P₁₄ | P₁₈ | Q_{9, 1}/R | 1.39 | |
| P₁₈ | P₈ | Q_{9, 2}/R | 0.96 | |
| P₈ | P₁₄ | Q_{9, 3}/R | 1.33 | |
| P₁₃ | P₁₇ | Q_{10, 1}/R | 1.22 | |
| P₁₇ | P₃ | Q_{10, 2}/R | 1.11 | |
| P₃ | P₁₃ | Q_{10, 3}/R | 1.45 | |
| P₁₃ | P₁₀ | Q_{11, 1}/R | 0.75 | |
| P₁₀ | P₈ | Q_{11, 2}/R | 1.45 | |
| P₈ | P₁₃ | Q_{11, 3}/R | 1.71 | |
| P₆ | P₅ | Q_{12, 1}/R | 1.21 | |
| P₅ | P₄ | Q_{12, 2}/R | 0.85 | |
| P₄ | P₆ | Q_{12, 3}/R | 1.51 | |
| P₁₀ | P₁₁ | Q_{13, 1}/R | 0.88 | |
| P₁₁ | P₁ | Q_{13, 2}/R | 1.84 | |
| P₁ | P₁₀ | Q_{13, 3}/R | 1.33 | |
| P₉ | p₄ | Q_{14, 1}/R | 1.12 | |
| P₄ | P₁₁ | Q_{14, 2}/R | 1.88 | |
| P₁₁ | P₉ | Q_{14, 3}/R | 1.05 | |
| P₈ | P₃ | Q_{15, 1}/R | 0.87 | |
| P₃ | P₇ | Q_{15, 2}/R | 0.90 | |
| P₇ | P₈ | Q_{15, 3}/R | 1.58 | |
| P₇ | P₁₇ | Q_{16, 1}/R | 0.76 | |
| P₁₇ | P₅ | Q_{16, 2}/R | 1.57 | |
| P₅ | P₇ | Q_{16, 3}/R | 1.67 | |
| P₁₆ | P₁₀ | Q_{17, 1}/R | 1.47 | |
| P₁₀ | P₇ | Q_{17, 2}/R | 1.21 | |
| P₇ | P₁₆ | Q_{17, 3}/R | 0.59 | |
| P₆ | P₁₂ | Q_{18, 1}/R | 0.67 | |
| P₁₂ | P₉ | Q_{18, 2}/R | 1.37 | |
| P₉ | P₆ | Q_{18, 3}/R | 1.62 | |

Other features which are considered as characteristic for the invention are set forth in the appended claims.

Although the invention is illustrated and described herein as embodied in a table tennis ball having a marking to make a ball rotation detectable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1 to 6 are six top view illustrations showing from six viewing directions perpendicular to one another, a table tennis ball having a spherical ball surface and a marking applied thereon for making the spin in flight metrologically detectable, wherein the marking is formed from eighteen marking points distributed on the ball surface; and

FIG. 7 is an illustration according to FIG. 1, showing a subgroup (“four-point network”) of the marking, which is formed from a first marking point of the marking viewed as the central point and its three closest neighboring points.

### DETAILED DESCRIPTION OF THE INVENTION

Parts, dimensions, and structures corresponding to one another are always provided with the same reference signs in all figures.

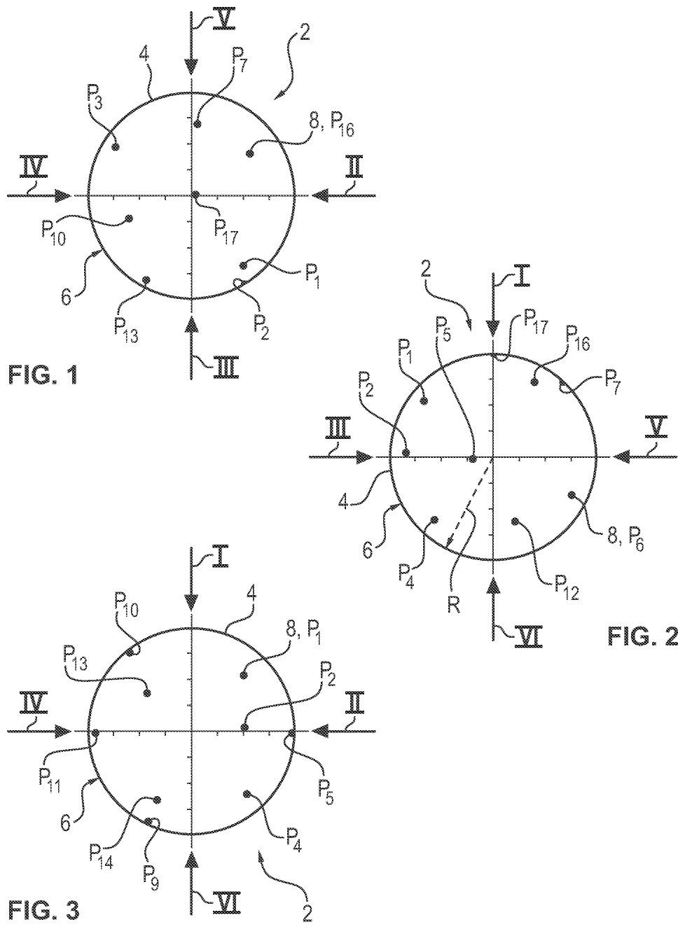

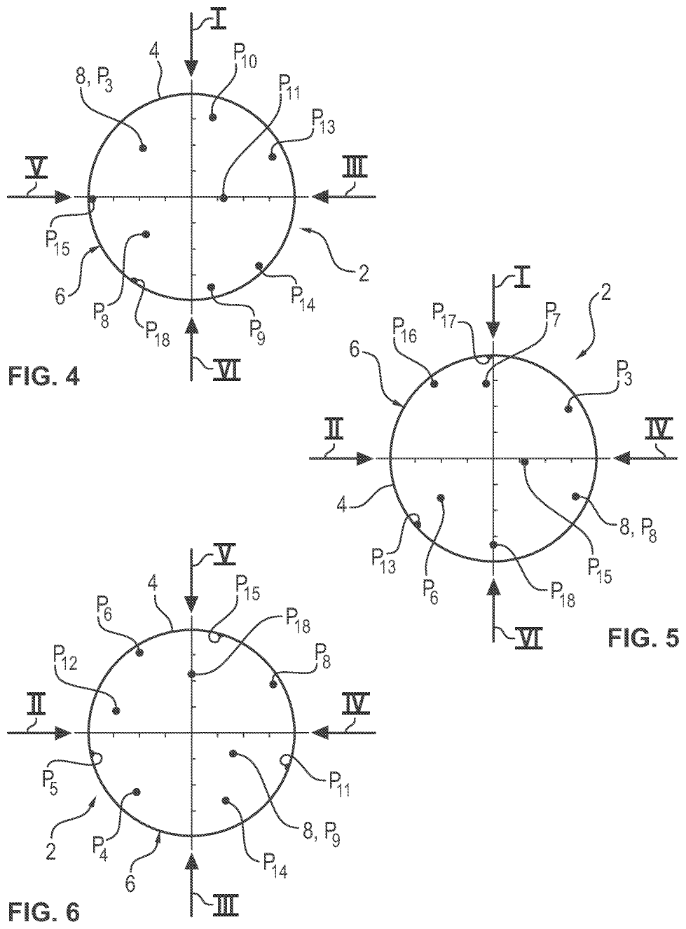

Referring now to the figures of the drawings in detail and first, particularly to FIGS. 1-6 thereof, there is shown in six top view illustrations from six viewing directions perpendicular to one another, a (table tennis) ball 2. The spatial relationship of the views shown in FIGS. 1 to 6 to one another is indicated in each of these figures by arrows inscribed with Roman numerals: The Roman numerals each indicate the viewing direction which underlies the respective figure corresponding to the numeric value. Thus, the arrow inscribed by the Roman numeral II in FIG. 1 indicates the viewing direction from which the view according to FIG. 2 results, etc.

The ball 2 typically has a hollow-spherical shell 4, in particular made of plastic. The ball 2 in particular has a ball radius R of 20 mm (millimeters) or a ball diameter of 40 mm, which conforms to the rules for table tennis.

In order to make the ball rotation (spin) metrologically detectable in flight of the ball 2, a spherical ball surface 6 of the shell 4 (and thus of the entire ball 2) is provided with a marking 8. The marking 8 consists in the illustrated example of eighteen marking points Pᵢ (with i=1, 2, . . . , 18), which are arranged distributed over the ball surface 6. In FIGS. 1 to 6, the marking 8 is schematically shown for better illustration. Perspective distortions of the marking points Pᵢ located at the edge of the respective visible part of the ball surface 6 are not shown.

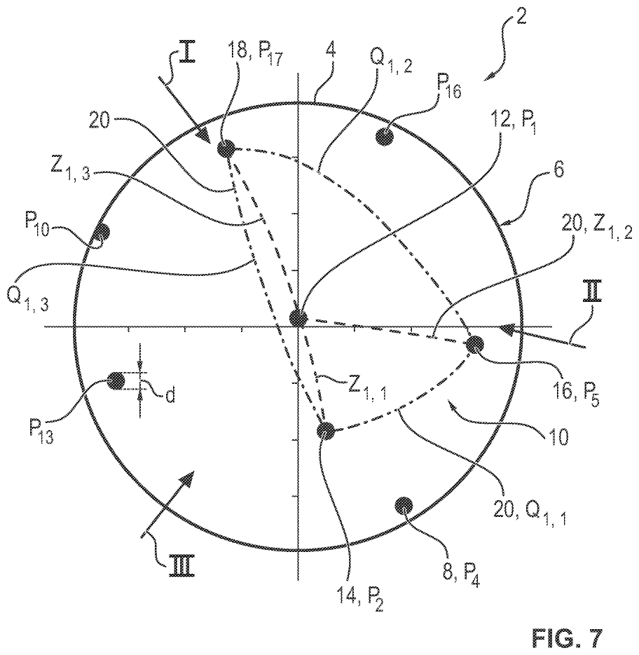

Each of the marking points Pᵢ is formed by a circular area having a diameter d (FIG. 7) of 3.5 mm (corresponding to 17.5% of the ball radius R). The marking points Pᵢ are applied to the ball surface 6 here using a strongly IR-absorbing and/or IR-reemitting paint, a strongly IR-absorbing and/or IR-reemitting printing ink/ink (see, for example, published, non-prosecuted German patent application DE 10 2008 049 595 A1), or another strongly IR-absorbing and/or IR-reemitting coating. In the visible spectral range of the electromagnetic radiation spectrum (thus in the spectral range of visible light), the marking points Pᵢ can have a color here which forms a color contrast to the surrounding ball surface 6. In this case, the marking points Pᵢ also stand out in an optically visible manner from the surrounding ball surface 6. The marking points Pᵢ are preferably transparent to the human eye, however, or have an identical or similar color as the surrounding ball surface 6. In the latter case, the marking points Pᵢ are only clearly recognizable in an infrared image of the ball 2, but in contrast they are not visible or in any case not conspicuous to a human observer and in light images of the ball 2.

Due to the above-described IR-sensitive embodiment of the marking 8, the marking points Pᵢ stand out in a strongly contrasting manner from the remaining ball surface 6 in an IR image of the ball 2. The ball 2 is optionally additionally provided with an additional structure (for example, an imprint or pattern), which is applied to the ball surface 6 at least by means of an ink that is not IR-absorbing or is less IR-absorbing. The marking 8 also stands out strongly in an IR image in relation to this possibly provided additional structure, so that in reverse the possibly provided structure does not impair or corrupt the information content conveyed by the marking 8 about the orientation of the ball 2 in space.

The location of the marking points Pᵢ on the ball surface 6 is specified in the following table in spherical coordinates, i.e., as a function of the polar angle Θ and the azimuth angle φ.

TABLE 3
The location of the marking points Pᵢ on the ball surface
of the table tennis ball in spherical coordinates

| marking point | polar angle Θ [°] | azimuth angle φ [°] |
|---|---|---|
| P₁ | 57.6 | 306.8 |
| P₂ | 88.2 | 301.2 |
| P₃ | 62.1 | 147.4 |
| P₄ | 128.2 | 313.0 |
| P₅ | 91.7 | 348.5 |
| P₆ | 112.3 | 56.8 |
| P₇ | 44.2 | 84.9 |
| P₈ | 111.8 | 151.3 |
| P₉ | 151.3 | 206.0 |
| P₁₀ | 40.7 | 199.6 |
| P₁₁ | 91.1 | 199.2 |
| P₁₂ | 129.7 | 16.2 |
| P₁₃ | 68.2 | 241.3 |
| P₁₄ | 132.0 | 242.1 |
| P₁₅ | 91.7 | 107.8 |
| P₁₆ | 44.4 | 35.5 |
| P₁₇ | 2.2 | 19.1 |
| P₁₈ | 145.5 | 91.6 |

In this arrangement, the marking points Pᵢ, viewed globally, are distributed homogeneously on the ball surface 6 in a rough approximation. However, the marking points Pᵢ are nonetheless arranged pseudo-randomly offset in a recognizable manner in relation to an ideal uniform distribution.

These properties of the point distribution are clear in particular upon observation of the local point environments (designated as four-point networks 10), which are each formed by one of the marking points Pᵢ as the central point 12 and by its three closest neighboring points Pᵢ. The marking 8 may be divided into eighteen (partially overlapping) four-point networks 10 in accordance with the number of the marking points Pᵢ.

The four-point network 10 of the first marking point Pᵢ is shown by way of example in FIG. 7. It is recognizable herein that:

a closest neighboring point 14 of the marking point Pᵢ is formed by the marking point P₂,
a second-closest neighboring point 16 of the marking point Pᵢ is formed by the marking point P₅, and
a third-closest neighboring point 18 of the marking point Pᵢ is formed by the marking point P₁₇.

As defined above, the lengths of the orthodromes 20, which connect the central point 12 of each four-point network 10 (in the example according to FIG. 7 the marking point Pᵢ) to in each case one of its neighboring points 14, 16, and 18 (in the example according to FIG. 7 thus the marking points P₂, P₅, and P₁₇, respectively) are designated as central point distances Z_{i,j}. The lengths of the orthodromes 20, which connect the neighboring points 14, 16, 18 of each four-point network 10 to one another, in contrast—as also defined above—are designated as peripheral point distances Q_{i,k}. For the four-point network 10 of the first marking point Pᵢ, the corresponding central point distances Z_{1,1}, Z_{1,2}, Z_{1,3} and peripheral point distances Q_{1,1}, Q_{1,2}, Q_{1,3} are entered in FIG. 7.

For the arrangement of the eighteen marking points Pᵢ indicated in Table 3, the values of the central point distances Z_{i,j} from the right column of Table 1.

According to equation 3, a mean value p results for the central point distances Z_{i,j}, which corresponds to 0.80 times the ball radius R (i.e., μ/R=0.80). At a ball radius R of 20 mm, the average point distance of each marking point Pᵢ from its three closest neighboring points is thus 16.1 mm (i.e., μ=16.1 mm). For the standard deviation a according to equation 2, a value of 0.126 results for the point distribution indicated in Table 3. The standard deviation a normalized to the mean value p is thus 15.7% (i.e., σ/μ=15.7%). The smallest (central) point distance dₘᵢₙ is formed between the points P₉ and P₁₄ and is 10.1 mm in the case of the ball radius indicated above. This corresponds to 63% of the mean value p (i.e., dₘᵢₙ=min {Z_{i,j},|i=1, . . . , N; j=1, 2, 3}=63%·μ).

The minimum point distance dₘᵢₙ is 53.6% of the typical distance d_{G} calculated according to equation 6 (equation 6) are—expressed equivalently—at least 214% of the quotient of the ball radius R to the square root of the point number N or 50.5% of the ball radius R.

With respect to the parameter σ/μ, the point distribution indicated in Table 3 is over the most ideal possible uniform distribution of the marking points Pᵢ; for such a uniform distribution of eighteen marking points Pᵢ, a comparative value of σ/μ=10.1% was found in experiments. On the other hand, the point distribution indicated in Table 3 also differs from an average random point distribution, in which the standard deviation a normalized to the mean value p is significantly higher, but the minimum central point distance regularly infringes the condition according to equation 4.

The peripheral point distances Q_{i,k} for the point arrangement from Table 3 result from the right column of Table 2. The range ΔQᵢ of this point arrangement normalized to the mean value p according to equation 8 is greater than or equal to 42.8% for all four-point networks 10 (min {ΔQᵢ/μ; i=1, 2, . . . , 18}=ΔQ₁₀/μ=42.8%).

The minimum value of this parameter ΔQᵢ, which represents a measure of the local irregularity of the point distribution, is significantly higher with the point distribution indicated in Table 3 than with the most ideal possible uniform distribution or an average random arrangement of the eighteen marking points Pᵢ.

The point distribution according to Table 3 is thus distinguished, viewed globally, by a pronounced uniformity, but viewed locally by a particularly high level of irregularity. Both features in combination facilitate the unambiguous identification of the marking points Pᵢ, each visible in arbitrary views of the ball 2, and thus decisively promote the spin ascertainment.

To determine the spin of the ball 2, a time sequence of images of the flying ball 2 is recorded by means of a camera. An infrared camera is preferably used for this purpose, in order to be able to utilize the strong contrast of the marking points Pᵢ in the IR spectrum. The camera is preferably arranged laterally to a table tennis table at the height of the net, so that it is aligned in parallel to the table transverse direction.

The recorded images of the ball 2 are evaluated, for example, using the method known from U.S. Pat. No. 7,062,082 B2, in order to determine the spin (in particular with respect to the axis of rotation, rotational direction, and rotational speed of the ball 2).

The marking 8 according to the invention, in particular in the embodiment shown in the figures and specified in detail in Table 3, enables for this purpose a particularly numerically uncomplicated and thus particularly fast spin ascertainment, by which for the first time a reasonable use of automatic spin ascertainment methods is enabled in table tennis, in particular in quasi-real time.

The invention is particularly clear in the exemplary embodiments described above, but is not restricted thereto. Rather, further embodiments of the invention can be derived from the claims and the preceding description.

The following is a summary list of reference numerals and the corresponding structure used in the above description of the invention.

### LIST OF REFERENCE SIGNS

2 ball
4 shell
6 ball surface
8 marking
10 four-point network
12 central point
14 (closest) neighboring point
16 (second-closest) neighboring point
18 (third-closest) neighboring point
20 orthodrome
d diameter (of the marking point)
Pᵢ marking points (i=1, 2, . . . , 18)
Z_{i,j} central point distance (i=1, 2, . . . , 18; j=1, 2, 3)
Q_{i,k} peripheral point distance (i=1, 2, . . . , 18; k=1, 2, 3)
R ball radius

1. A table tennis ball, comprising:
a spherical ball surface; and
a marking applied to said spherical ball surface for making a ball rotation metrologically detectable, said marking having a number of marking points, said marking points being distributed on said spherical ball surface such that a standard deviation of lengths of orthodromes between each of said marking points and its three closest neighboring marking points is at least 12% of a mean value of the lengths, and that a minimum length of the orthodromes between each of said marking points and its said three closest neighboring marking points is at least 40% of the mean value of the lengths and/or at least 120% of a quotient of a ball radius to a square root of the number of said marking points.

2. The table tennis ball according to in claim 1, wherein said marking points are distributed on said spherical ball surface such that the standard deviation of the lengths of the orthodromes between each of said marking points and its said three closest neighboring points is at least 15% of the mean value of the lengths.

3. The table tennis ball according to claim 1, wherein the minimum length of the orthodromes between each of said marking points and its said three closest neighboring points is at least 50% of the mean value of the lengths.

4. The table tennis ball according to claim 1, wherein the minimum length of the orthodromes between each of said marking points and its said three closest neighboring points is at least 150% of the quotient of the ball radius to the square root of the number of said marking points.

5. The table tennis ball according to claim 1, wherein said marking points are distributed on said spherical ball surface such that a range of the lengths of the orthodromes, which connect said three closest neighboring points of each said marking point to one another, is greater than 30% of the mean value of the lengths of the orthodromes between each of said marking points and its said three closest neighboring points.

6. The table tennis ball according to claim 1, wherein the number of said marking points is between 13 and 25.

7. The table tennis ball according to claim 1, wherein a diameter of each said marking point is between 10% and 24% of the ball radius.

8. The table tennis ball according to claim 1, wherein a diameter of each said marking point is between 2.0 mm and 4.8 mm.

9. The table tennis ball according to claim 1, wherein all of said marking points have a same shape and size.

10. The table tennis ball according to claim 1, wherein said marking points have an infrared absorption and/or infrared reemission characteristic different from remaining said spherical ball surface, so that said marking points stand out from said remaining spherical ball surface in a contrasting manner in an infrared range of an electromagnetic radiation spectrum.

11. The table tennis ball according to claim 1, wherein said marking points have a color different from remaining said spherical ball surface, so that said marking points stand out from said remaining spherical ball surface in a contrasting manner in a visible range of electromagnetic radiation spectrum.

12. The table tennis ball according to claim 1, wherein the minimum length of the orthodromes between each of said marking points and its said three closest neighboring points is at least 60% of the mean value of the lengths.

13. The table tennis ball according to claim 1, wherein the minimum length of the orthodromes between each of said marking points and its said three closest neighboring points is at least 180% of the quotient of the ball radius to the square root of the number of said marking points.

14. The table tennis ball according to claim 1, wherein said marking points are distributed on said spherical ball surface such that a range of the lengths of the orthodromes, which connect said three closest neighboring points of each said marking point to one another, is greater than 35% of the mean value of the lengths of the orthodromes between each of said marking points and its said three closest neighboring points.

15. The table tennis ball according to claim 1, wherein said marking points are distributed on said spherical ball surface such that a range of the lengths of the orthodromes, which connect said three closest neighboring points of each said marking point to one another, is greater than 40% of the mean value of the lengths of the orthodromes between each of said marking points and its said three closest neighboring points.

16. The table tennis ball according to claim 1, wherein the number of said marking points is between 18 and 19.

17. The table tennis ball according to claim 1, wherein a diameter of each said marking point is 17.5%.

18. A table tennis ball, comprising:
spherical ball surface;
a marking applied to said spherical ball surface for making a ball rotation metrologically detectable, wherein said marking has a number of marking points, said marking having eighteen of said marking points;
wherein starting from a first marking point of said marking points:
a length of an orthodrome to its closest neighboring marking point in relation to a ball radius is 0.54±20%;
a length of an orthodrome to its second-closest neighboring marking point in relation to the ball radius is 0.91±20%; and
a length of an orthodrome to its third-closest neighboring marking point in relation to the ball radius is 0.99±20%;
wherein starting from a second marking point of said marking points:
a length of an orthodrome to its closest neighboring point in relation to the ball radius is 0.54±20%;
a length of an orthodrome to its second-closest neighboring point in relation to the ball radius is 0.72±20%; and
a length of an orthodrome to its third-closest neighboring point in relation to the ball radius is 0.83±20%;
wherein starting from a third marking point of said marking points:
a length of an orthodrome to its closest neighboring point in relation to the ball radius is 0.78±20%;
a length of an orthodrome to its second-closest neighboring point in relation to the ball radius is 0.84±20%; and
a length of an orthodrome to its third-closest neighboring point in relation to the ball radius is 0.87±20%;
wherein starting from a fourth marking point of said marking points:
a length of an orthodrome to its closest neighboring point in relation to the ball radius is 0.72±20%;
a length of an orthodrome to its second-closest neighboring point in relation to the ball radius is 0.84±20%; and
a length of an orthodrome to its third-closest neighboring point in relation to the ball radius is 0.85±20%;
wherein starting from a fifth marking point of said marking points:
a length of an orthodrome to its closest neighboring point in relation to the ball radius is 0.79±20%;
a length of an orthodrome to its second-closest neighboring point in relation to the ball radius is 0.83±20%; and
a length of an orthodrome to its third-closest neighboring point in relation to the ball radius is 0.85±20%;
wherein starting from a sixth marking point of said marking points:
a length of an orthodrome to its closest neighboring point in relation to the ball radius is 0.67±20%;
a length of an orthodrome to its second-closest neighboring point in relation to the ball radius is 0.73±20%; and
a length of an orthodrome to its third-closest neighboring point in relation to the ball radius is 0.94±20%;
wherein starting from a seventh marking point of said marking points:
a length of an orthodrome to its closest neighboring point in relation to the ball radius is 0.59±20%;
a length of an orthodrome to its second-closest neighboring point in relation to the ball radius is 0.76±20%; and
a length of an orthodrome to its third-closest neighboring point in relation to the ball radius is 0.90±20%;
wherein starting from an eighth marking point of said marking points:
a length of the orthodrome to its closest neighboring point in relation to the ball radius is 0.82±20%;
a length of an orthodrome to its second-closest neighboring point in relation to the ball radius is 0.87±20%; and
a length of the orthodrome to its third-closest neighboring point in relation to the ball radius is 0.89±20%;
wherein starting from a ninth marking point of said marking points:
a length of an orthodrome to its closest neighboring point in relation to the ball radius is 0.51±20%;
a length of an orthodrome to its second-closest neighboring point in relation to the ball radius is 0.91±20%; and
a length of an orthodrome to its third-closest neighboring point in relation to the ball radius is 0.95±20%;
wherein starting from a tenth marking point of said marking points:
a length of an orthodrome to its closest neighboring point in relation to the ball radius is 0.75±20%;
a length of an orthodrome to its second-closest neighboring point in relation to the ball radius is 0.75±20%; and
a length of an orthodrome to its third-closest neighboring point in relation to the ball radius is 0.78±20%;
wherein starting from an eleventh marking point of said marking points:
a length of an orthodrome to its closest neighboring point in relation to the ball radius is 0.82±20%;
a length of an orthodrome to its second-closest neighboring point in relation to the ball radius is 0.88±20%; and
a length of an orthodrome to its third-closest neighboring point in relation to the ball radius is 0.89±20%;
wherein starting from a twelfth marking point of said marking points:
a length of an orthodrome to its closest neighboring point in relation to the ball radius is 0.67±20%;
a length of an orthodrome to its second-closest neighboring point in relation to the ball radius is 0.79±20%; and
a length of an orthodrome to its third-closest neighboring point in relation to the ball radius is 0.84±20%;
wherein starting from a thirteenth marking point of said marking points:
a length of an orthodrome to its closest neighboring point in relation to the ball radius is 0.75±20%;
a length of an orthodrome to its second-closest neighboring point in relation to the ball radius is 0.82±20%; and
a length of an orthodrome to its third-closest neighboring point in relation to the ball radius is 1.02±20%;
wherein starting from a fourteenth marking point of said marking points:
a length of an orthodrome to its closest neighboring point in relation to the ball radius is 0.51±20%;
a length of an orthodrome to its second-closest neighboring point in relation to the ball radius is 0.92±20%; and
a length of an orthodrome to its third-closest neighboring point in relation to the ball radius is 0.98±20%;
wherein starting from a fifteenth marking point of said marking points:
a length of an orthodrome to its closest neighboring point in relation to the ball radius is 0.82±20%;
a length of an orthodrome to its second-closest neighboring point in relation to the ball radius is 0.84±20%; and
a length of an orthodrome to its third-closest neighboring point in relation to the ball radius is 0.90±20%;
wherein starting from a sixteenth marking point of said marking points:
a length of an orthodrome to its closest neighboring point in relation to the ball radius is 0.59±20%;
a length of an orthodrome to its second-closest neighboring point in relation to the ball radius is 0.74±20%; and
a length of an orthodrome to its third-closest neighboring point in relation to the ball radius is 1.10±20%;
wherein starting from a seventeenth marking point of said marking points:
a length of an orthodrome to its closest neighboring point in relation to the ball radius is 0.74±20%;
a length of an orthodrome to its second-closest neighboring point in relation to the ball radius is 0.75±20%; and
a length of an orthodrome to its third-closest neighboring point in relation to the ball radius is 0.76±20%; and
wherein starting from an eighteenth marking point of said marking points:
a length of an orthodrome to its closest neighboring point in relation to the ball radius is 0.73±20%;
a length of an orthodrome to its second-closest neighboring point in relation to the ball radius is 0.88±20%; and
a length of an orthodrome to its third-closest neighboring point in relation to the ball radius is 0.91±20%.

19. The table tennis ball according to claim 18,
wherein for the first marking point:
a length of an orthodrome between the closest neighboring point and the second-closest neighboring point in relation to the ball radius is 0.83±20%;
a length of an orthodrome between the second-closest neighboring point and the third-closest neighboring point in relation to the ball radius is 1.57±20%; and
a length of an orthodrome between the third-closest neighboring point and the closest neighboring point in relation to the ball radius is 1.53±20%;
wherein for the second marking point:
a length of an orthodrome between the closest neighboring point and the second-closest neighboring point in relation to the ball radius is 1.24±20%;
a length of an orthodrome between the second-closest neighboring point and the third-closest neighboring point in relation to the ball radius is 0.85±20%; and
a length of an orthodrome between the third-closest neighboring point and the closest neighboring point in relation to the ball radius is 0.91±20%;
wherein for the third marking point:
a length of an orthodrome between the closest neighboring point and the second-closest neighboring point in relation to the ball radius is 1.61±20%;
a length of an orthodrome between the second-closest neighboring point and the third-closest neighboring point in relation to the ball radius is 0.82±20%; and
a length of an orthodrome between the third-closest neighboring point and the closest neighboring point in relation to the ball radius is 1.45±20%;
wherein for the fourth marking point:
a length of an orthodrome between the closest neighboring point and the second-closest neighboring point in relation to the ball radius is 1.39±20%;
a length of an orthodrome between the second-closest neighboring point and the third-closest neighboring point in relation to the ball radius is 0.79±20%; and
a length of an orthodrome between the third-closest neighboring point and the closest neighboring point in relation to the ball radius is 0.83±20%;
wherein for the fifth marking point:
a length of an orthodrome between the closest neighboring point and the second-closest neighboring point in relation to the ball radius is 1.39±20%;
a length of an orthodrome between the second-closest neighboring point and the third-closest neighboring point in relation to the ball radius is 0.72±20%; and
a length of an orthodrome between the third-closest neighboring point and the closest neighboring point in relation to the ball radius is 0.84±20%;
wherein for the sixth marking point:
a length of an orthodrome between the closest neighboring point and the second-closest neighboring point in relation to the ball radius is 0.88±20%;
a length of an orthodrome between the second-closest neighboring point and the third-closest neighboring point in relation to the ball radius is 0.97±20%; and
a length of an orthodrome between the third-closest neighboring point and the closest neighboring point in relation to the ball radius is 1.57±20%;
wherein for the seventh marking point:
a length of an orthodrome between the closest neighboring point and the second-closest neighboring point in relation to the ball radius is 0.74±20%;
a length of an orthodrome between the second-closest neighboring point and the third-closest neighboring point in relation to the ball radius is 1.60±20%; and
a length of an orthodrome between the third-closest neighboring point and the closest neighboring point in relation to the ball radius is 1.38±20%;
wherein for the eighth marking point:
a length of an orthodrome between the closest neighboring point and the second-closest neighboring point in relation to the ball radius is 0.84±20%;
a length of an orthodrome between the second-closest neighboring point and the third-closest neighboring point in relation to the ball radius is 1.00±20%; and
a length of an orthodrome between the third-closest neighboring point and the closest neighboring point in relation to the ball radius is 1.59±20%;
wherein for the ninth marking point:
a length of an orthodrome between the closest neighboring point and the second-closest neighboring point in relation to the ball radius is 1.39±20%;
a length of an orthodrome between the second-closest neighboring point and the third-closest neighboring point in relation to the ball radius is 0.96±20%; and
a length of an orthodrome between the third-closest neighboring point and the closest neighboring point in relation to the ball radius is 1.33±20%;
wherein for the tenth marking point:
a length of an orthodrome between the closest neighboring point and the second-closest neighboring point in relation to the ball radius is 1.22±20%;
a length of an orthodrome between the second-closest neighboring point and the third-closest neighboring point in relation to the ball radius is 1.11±20%; and
a length of an orthodrome between the third-closest neighboring point and the closest neighboring point in relation to the ball radius is 1.45±20%;
wherein for the eleventh marking point:
a length of an orthodrome between the closest neighboring point and the second-closest neighboring point in relation to the ball radius is 0.75±20%;
a length of an orthodrome between the second-closest neighboring point and the third-closest neighboring point in relation to the ball radius is 1.45±20%; and
a length of an orthodrome between the third-closest neighboring point and the closest neighboring point in relation to the ball radius is 1.71±20%;
wherein for the twelfth marking point:
a length of an orthodrome between the closest neighboring point and the second-closest neighboring point in relation to the ball radius is 1.21±20%;
a length of an orthodrome between the second-closest neighboring point and the third-closest neighboring point in relation to the ball radius is 0.85±20%; and
a length of an orthodrome between the third-closest neighboring point and the closest neighboring point in relation to the ball radius is 1.51±20%;
wherein for the thirteenth marking point:
a length of an orthodrome between the closest neighboring point and the second-closest neighboring point in relation to the ball radius is 0.88±20%;
a length of an orthodrome between the second-closest neighboring point and the third-closest neighboring point in relation to the ball radius is 1.84±20%; and
a length of an orthodrome between the third-closest neighboring point and the closest neighboring point in relation to the ball radius is 1.33±20%;
wherein for the fourteenth marking point:
a length of an orthodrome between the closest neighboring point and the second-closest neighboring point in relation to the ball radius is 1.12±20%;
a length of an orthodrome between the second-closest neighboring point and the third-closest neighboring point in relation to the ball radius is 1.88±20%; and
a length of an orthodrome between the third-closest neighboring point and the closest neighboring point in relation to the ball radius is 1.05±20%;
wherein for the fifteenth marking point:
a length of an orthodrome between the closest neighboring point and the second-closest neighboring point in relation to the ball radius is 0.87±20%;
a length of an orthodrome between the second-closest neighboring point and the third-closest neighboring point in relation to the ball radius is 0.90±20%; and
a length of an orthodrome between the third-closest neighboring point and the closest neighboring point in relation to the ball radius is 1.58±20%;
wherein for the sixteenth marking point:
a length of an orthodrome between the closest neighboring point and the second-closest neighboring point in relation to the ball radius is 0.76±20%;
a length of an orthodrome between the second-closest neighboring point and the third-closest neighboring point in relation to the ball radius is 1.57±20%; and
a length of an orthodrome between the third-closest neighboring point and the closest neighboring point in relation to the ball radius is 1.67±20%;
wherein for the seventeenth marking point:
a length of an orthodrome between the closest neighboring point and the second-closest neighboring point in relation to the ball radius is 1.47±20%;
a length of an orthodrome between the second-closest neighboring point and the third-closest neighboring point in relation to the ball radius is 1.21±20%; and
a length of an orthodrome between the third-closest neighboring point and the closest neighboring point in relation to the ball radius is 0.59±20%; and
wherein for the eighteenth marking point:
a length of an orthodrome between the closest neighboring point and the second-closest neighboring point in relation to the ball radius is 0.67±20%;
a length of an orthodrome between the second-closest neighboring point and the third-closest neighboring point in relation to the ball radius is 1.37±20%; and
a length of an orthodrome between the third-closest neighboring point and the closest neighboring point in relation to the ball radius is 1.62±20%.
